(19) United States
(12) Patent Application Publication
(10) Pub. No.: US 2014/0088999 A1
(43) Pub. Date: Mar. 27, 2014

(54) MEDICAL CLAIMS PAYMENT SYSTEM WITH PAYMENT CONSOLIDATION FROM MULTIPLE EMPLOYER ACCOUNTS

(71) Applicant: ELECTRONIC COMMERCE FOR HEALTHCARE ORGANIZATION, INC., WestLake, OH (US)

(72) Inventors: William H. DAVIS, Fairview Park, OH (US); William A. MINNICH, Lakewood, OH (US); George O. DONOVAN, New York, NY (US); John J. GOBA, Westlake, OH (US); Robert E. STRICKLAND, Duluth, GA (US)

(73) Assignee: ELECTRONIC COMMERCE FOR HEALTHCARE ORGANIZATIONS, INC., Westlake, OH (US)

(21) Appl. No.: 14/091,396

(22) Filed: Nov. 27, 2013

Related U.S. Application Data
(63) Continuation-in-part of application No. 13/334,312, filed on Dec. 22, 2011, now Pat. No. 8,626,536.
Application No. 13/334,312 is a continuation-in-part of application No. 10/930,499, filed on Aug. 31, 2004, now abandoned.

(51) Int. Cl. G06Q 20/10; G06Q 50/22

(52) U.S. Cl. CPC G06Q 20/102; G06Q 40/08; G06Q 50/22
USPC 705/2

(57) ABSTRACT

Segregated employer group settlement accounts (10₁, 10₂, . . . , 10_{N}) receive payments for medical insurance claims and an explanation of benefits (EOB) memory (14) receives an explanation of the medical services of multiple medical service providers against which parts of the payment are to be applied and explanations of amounts due by individual patients. An electronic sorting and transfer processor (16) in accordance with the explanations of benefits, electronically transfers funds from each of the employer group settlement accounts into each of a plurality of medical service provider settlement accounts (26₁, 26₂, . . . 26_{M}) without co-mingling funds. The funds from the service provider settlement accounts are transferred (30) to each medical service provider's banking institution (32) concurrently with an electronic transfer of the corresponding EOBs to the medical service provider's accounting system (34).

This application is a continuation-in-part of and claims the benefit of U.S. application Ser. No. 13/334,312, filed Dec. 22, 2011, now U.S. Pat. No. ______, which is a continuation-in-part of and claims the benefit of U.S. application Ser. No. 10/930,499, filed Aug. 31, 2004, now abandoned. This application deletes the subject matter added in U.S. application Ser. No. 13/334,312 and is the same as U.S. application Ser. No. 10/930,499.

### BACKGROUND OF THE INVENTION

The present invention pertains to the payment of insurance, particularly medical insurance claims.

Currently, there are thousands of medical health insurance plans. Major employers negotiate custom medical insurance plans for their employees. Other companies select one of several insurance plans offered by an insurance company which may or may not include various options. Small business associations negotiate yet other health insurance contracts. The employees within these various employer groups obtain medical services at a plurality of covered medical facilities. Conversely, the various medical facilities treat patients with a myriad of different health plans.

The Employee Retirement Income Security Act (ERISA) prohibits the co-mingling of health insurance payments. A single instrument, such as a check, cannot be issued that shares risk. This results in insurance companies issuing a very large number of checks, and medical providers receiving large numbers of checks. Payment consolidators function as a go-between between the payers and the medical service providers. However, they too are bound by the ERISA rules against co-mingling of funds and must take care to avoid co-mingling funds received from payees and issue a multitude of checks to the various medical providers. Typically, a consolidator must send a medical provider a different and separate check for funds from each payee.

The funds are accompanied by an Explanation of Benefits (EOB) which is formatted and the contents normalized to the ANSI-835 standard. However, the normalized content is not standardized from employer group to employer group. Even though the normalized content may specify such terms as “non-covered” or “pending”, different health insurance contracts give different meanings to these terms. It is often difficult for the medical provider to determine, to a certainty, such simple information as the patient's co-pay, what amounts may be billed to the patient, which amounts must be written off, and the like. Determining this information generally requires a custom interpretation of the EOB from each of the various employer groups. Such individual interpretation is labor-intensive and expensive to the medical service providers. Moreover, due to the uncertainty regarding which charges must be written off and which may be billed to the patient, patients are often billed for charges which their insurance contract requires to be written off.

The present application provides a new and improved automated payment system which overcomes these problems and others.

### SUMMARY OF THE INVENTION

In accordance with one aspect of the present invention, a method of paying medical claims is provided. Medical insurance payments are received from each of a plurality of employer groups in segregated employer group settlement accounts which are segregated by employer group. The employer group payments each include payments corresponding to multiple patients for a plurality of medical service providers. Explanations of the payments, including at least employer group, patient identification, a service provider identification and amounts paid, are also received. In accordance with the explanations, payments are transferred from the corresponding employer group settlement accounts into a plurality of corresponding service provider settlement accounts without co-mingling funds.

In accordance with another aspect of the present invention, an apparatus is provided for paying medical claims. A plurality of segregated employer group settlement accounts each receive medical insurance payments from one of a plurality of employer groups. The employer group payments each include payments corresponding to multiple patients for a plurality of medical service providers. An explanation memory receives explanations of the payments, including at least the employer group, a patient identification, a service provider identification, and amounts paid. A plurality of service provider settlement accounts each holds funds of one of the service providers. A computer means transfers the payments from the corresponding employer group settlement account into the corresponding service provider settlement account in accordance with the explanations without co-mingling funds.

One advantage of the present invention is that it reduces the number of paper checks processed and is particularly amenable to electronic funds transfers.

Another advantage of the present invention resides in the standardization of information regarding benefits which are the responsibility of the insurance company and benefits which are the responsibility of the patient.

Another advantage of the present invention resides in reduced processing of insurance payments by medical providers.

Another advantage of the present invention resides in the improvement of patients' understanding of their medical coverage.

Another advantage of the present invention is that it helps assure that charges and payments are properly applied.

Still further advantages of the present invention will be appreciated to those of ordinary skill in the art upon reading and understand the following detailed description.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 is a diagrammatic illustration of an automated claim processing system in accordance with the present invention.

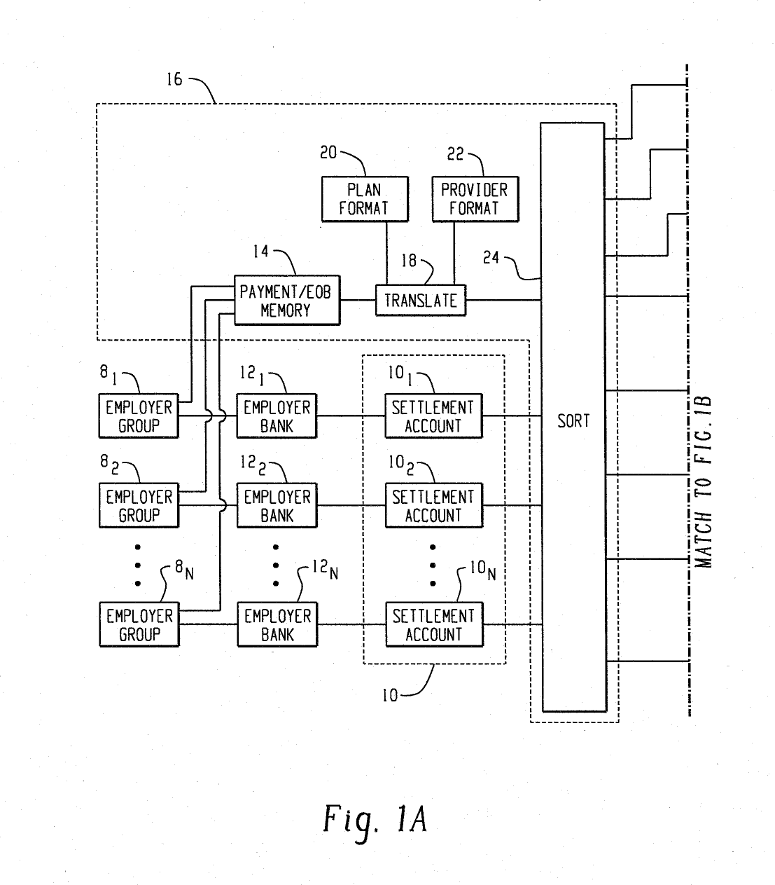

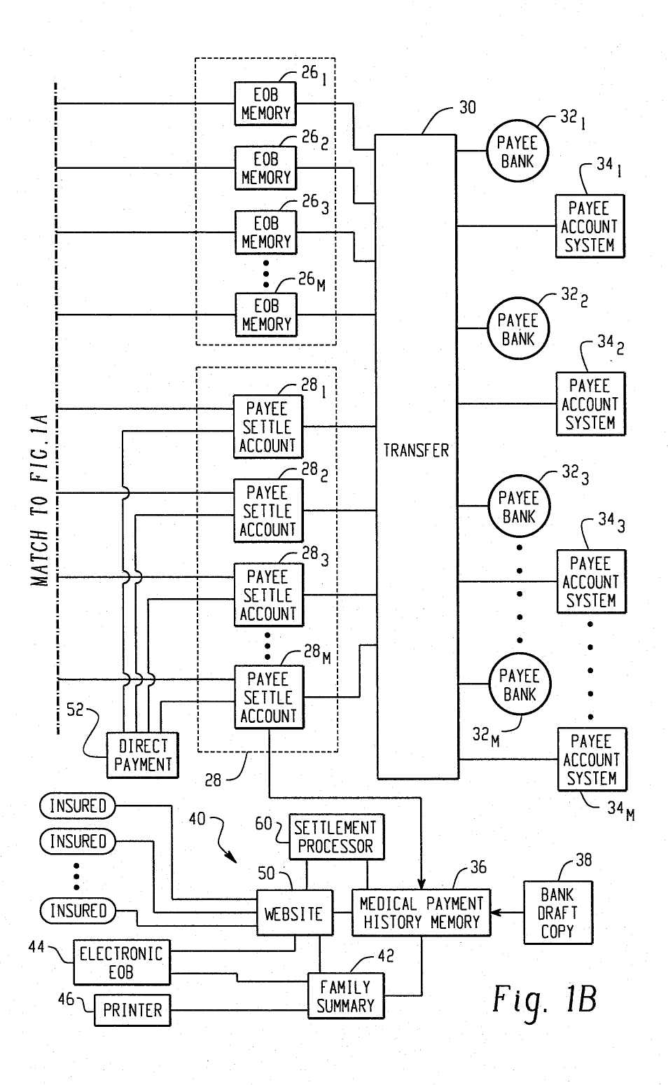

### DETAILED DESCRIPTION OF THE PREFERRED EMBODIMENTS

A plurality of employer groups 8₁, 8₂, . . . 8_{N}, each have a corresponding health insurance policy which specifies coverage, co-payments, other patient responsibilities, and the like. Each of the employer groups is associated with one or more traditional insurance carriers. For employer groups that are partially self-insured or self-funded, the employer is typically a co-insurer with an insurance company. Conversely, a common insurance carrier may underwrite several employer groups.

A series 10 of N segregated employer group settlement accounts 10₁, 10₂, . . . 10_{N}, are each associated with one of the employer groups. Typically, each employer settlement group is associated with one settlement account. In some instances, such as with co-insurance or multiple insurance carriers, an employer settlement group might be associated with two or more settlement accounts. However, each settlement account is associated with only one employer group. More specifically, the employer group settlement accounts are segregated accounts which are each accessible to the corresponding employer group, but not to other employer groups. Creditors of one employer group cannot reach the settlement accounts of other employer groups to avoid violations of the prohibition of co-mingling of funds. The array of settlement accounts are preferably with a common financial institution for funds transfer simplicity, but can also be with different institutions.

Each employer group adjudicates medical claims of its members and periodically, e.g., weekly, causes its bank 12₁, 12₂, . . . 12_{N} to issue a payment for all of the adjudicated claims of the employer group into the corresponding employer group's settlement account and sends an electronic description of the payments to a common payment memory 14. More specifically, each employer group sends Explanations of Benefits (EOBs) explaining the benefits paid, the patient information, the medical service provider information, and the like, for each of the batch of adjudicated claims. A common EOB memory 14 can store the payment descriptions of multiple payers without violating co-mingling rules. A payment allocation comparator routine or processor 16 includes an EOB translating routine or processor 18 which translates each of the EOBs from the form, format, and content of the employer group to a preferred form, format, and content of the service provider that is identified on each electronic EOB as having provided the service(s).

The electronic EOBs stored in the EOB memory 14 are preferably segregated or at least identified by employer group. The translator routine 18 accesses an employer group plan memory 20 to identify the form, format, and content of the EOB corresponding to each employer group and addresses a medical provider form, format, and content memory 22 to determine the form, format, and content preferred by each of the multiplicity of medical service providers. Because many medical service providers have a very high percentage of their medical claims paid by Medicare, they are well-equipped to handle the form, format, interpretation, and content used by Medicare. Accordingly, this form, format, interpretation, and content is often, but not always, preferred by medical service providers.

A sorting routine or processor 24 sorts the translated EOBs into a series 26 of EOB memories 26₁, 26₂, . . . , 26_{M}, each EOB memory corresponding to one of M medical service providers. Concurrently, the sort routine 24 transfers the amount of money specified on each EOB individually from the employer group settlement account of the corresponding employer group to a one of a plurality of payee or service provider settlement accounts 28₁, 28₂, . . . , 28_{M} corresponding to the identified service providers. More specifically, the money is transferred by a series of electronic funds transfers. More preferably, all of the payee settlement accounts 28 and all of the employer group settlement accounts are all located in the same banking institution to simplify and expedite the numerous monetary transfers.

A transfer means 30 periodically transfers the monies in the payee settlement account 28m corresponding to each medical service provider to their normal business bank account 32₁, 32₂, . . . , 32_{M} which is typically in another banking institution. Although the transfer means 30 preferably makes electronic transfers on a periodic basis, e.g., daily, twice weekly, weekly, the transfer means 30 may also transfer the money by printing a bank draft. To avoid co-mingling problems, the transfer means uses a bank draft which is payable on presentation as opposed to a check which is payable when received. Concurrently, the transfer means 30 transfers the translated electronic EOBs from the set 26 of EOB memories to the electronic accounting systems 34₁, 34₂, . . . 34_{M} of the medical service providers. In this manner, all of the payments are maintained separated and not co-mingled until they become the property of the medical service provider.

Concurrently, the transfer means 30 transfers the EOB and electronic funds transfer information to a medical payment history memory 36 which maintains a record of the EOB information, payments made, electronic transfer and routing information, and the like, which can be used to verify payment of the monies and trace such payments. If the transfer means transfers the funds by draft, the payment history memory 36 also records the draft number. Preferably, a draft copying means 38 copies each of the drafts when they are returned and cleared by the banking institution holding the payee settlement accounts. This photographing means may be the photographing means which banks typically use currently, or may a redundant operation. The copies of the cashed drafts are transferred to the payment history memory means for storage in conjunction with the corresponding payment information to provide a traceable history that the payment was, in fact, made and deposited. The medical payment history memory is preferably accessible on a read-only basis by both employer group insurers and medical service providers to check and confirm payments.

A direct consumer interface system 40 enables patients to access their own medical payment records, receive EOBs and payment notices on-line, and to pay patient responsibility portions of the bill on-line. More specifically to the preferred embodiment, a family summary means or routine 42 groups new EOBs in the payment history memory 36 by patient and, more specifically, by groups of all of the patients within a single insured's family. An electronic transfer routine or processor 44 e-mails all new family EOBs to the insured patient or other designee on a periodic basis. For example, new EOBs are sent on a weekly basis, monthly basis, or other appropriate basis. For insureds who prefer paper EOBs to electronic copies, a printing and mailing system 46 prints the new EOBs for each family group and sends them by post.

The e-mail reporting of the EOB can be done in the conventional EOB form, format, and content of the employer group, or in a standardized EOB format which more clearly specifies the amounts paid to the service providers, the amounts required to be written off, and the amount which is the patient's responsibility.

A patient accessible website 50 is accessible electronically, preferably via the internet, by individual patients. Through the website 50, the patient can check theirs and their family's medical payment histories through the medical payment history memory 36. Preferably, the website 50 is linked to a direct payment website 52. Through the direct payment website, the patients can make internet payment transactions, e.g., by credit card, to transfer funds to cover the patient responsibility portion of the medical services directly to the payee settlement accounts 28. The website 50 or the direct payee payment site 52 also sends the corresponding patient and EOB information to the corresponding EOB memories. Preferably, the direct payment site pays multiple medical service providers payment settlements accounts with a single credit card or other electronic money transfer operation of the patient.

Optionally, a computer-based collection/settlement routine or processor 60 under contract with all or selected medical service providers searches the medical payment memory 36 for delinquent and overdue accounts. The collection routine electronically compares the payment history and amounts due with compromise criteria and compromise limitations provided by the corresponding medical service provider(s). Based on these guidelines, the collection/settlement routine e-mails or mails by post, an offer to compromise the patient responsibility portion of the outstanding medical claims in exchange for immediate payment. Alternately, the information can be printed out or displayed for a human collections officer, who makes the offers by telephone. Upon receipt of the payments, the credit and collection routine includes a means or subroutine for forwarding the payment and write-off information to the corresponding EOB memories 26, and for transferring the collected monies (less a commission) to a sub-account of the corresponding payee settlement account. The commission is transferred to a separate collection commission account.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1-16. (canceled)

17. A method of facilitating payment of adjudicated health care benefits to a health care provider on behalf of a payer comprising the steps of:
adjudicating a benefit payment by evaluating a benefit claim under the terms of an applicable medical benefits policy and calculating an amount of a payable benefit;
designating a unique card account by one or more computers, the card account being charged only up to the amount of the payable benefit;
transferring funds from the card account designated by a payer by one or more computers in the amount of the adjudicated benefit payment;
generating an explanation of benefits associated with the payment;
creating a file containing the card account number, the adjudicated benefit payment amount, and the explanation of benefits by one or more computers; and
sending the file to the health care provider.

18. The method of claim 17 further comprising the step of reconciling the charged card account to confirm that the health care provider has received payment.

19. A system for payment of health care benefits combining payment terms and an explanation of benefits, the system comprising:
an explanation of benefits describing medical services provided to a patient by a health care provider, an amount billed by the health care provider and an amount paid by the patient's insurance company; and
a payment mechanism associated with the explanation of benefits, the payment mechanism merging electronic routing and transfer information, an adjudicated benefit payment amount with the explanation of benefits into a document by one or more computers;
wherein funds in the amount of an adjudicated benefit payment are transferred from an account designated by the insurance company value card account and wherein the document is sent to the health care provider as payment for the medical services.

20. The system of claim 19 further including reconciling to confirm that the healthcare provider has received payment.

21. A computer implemented method for combining payment of health care benefits with an associated explanation of benefits, the method comprising:
receiving an explanation of benefits related to medical services provided by a health care provider;
receiving authorization to pay at least a portion of submitted charges associated with the explanation of benefits and the associated funds for payment;
transferring funds from an account designated by a payer by an electronic funds transfer or bank draft in an amount equal to the adjudicated benefit payment by one or more computers, only up to the transferred amount; and
merging the explanation of benefits with electronic funds transfer and routing information and a number of the bank draft and the adjudicated benefit amount of payment.

22. The method of claim 21 further including:
reconciling to confirm that the health care provider has received payment.

23. A system for payment of health care benefits to a health care provider, the system comprising:
an administration system operable to receive a benefit claim from the health care provider and to generate an explanation of benefits for the benefit claim along with an approved payment, wherein the amount of approved payment is adjudicated by evaluating the benefit claim under the terms of an applicable medical benefits policy; and
a processing system operable to transfer funds from an account designated by a payer in an amount equal to the approved payment by one or more computers, the processing system also operable to merge the explanation of benefits with funds transfer information by one or more computers, the adjudicated amount of payment and to send the file to the health care provider as payment for the benefit claim.

24. The system of claim 23 further including:
reconciling to confirm that the health care provider has received payment.

25. A computer implement method for combining payments of healthcare benefits, the method comprising:
receiving adjudicated Explanations of Benefits (EOBs) and receiving payment from a plurality of insurers for covered medical services delivered by a plurality of providers to a plurality of patients;
aggregating payments to one of the providers for services delivered to a plurality of the patients into a single aggregated payment;
transferring the aggregated payment to the one of the providers, and concurrently transferring the EOBs corresponding to the delivered services covered by the aggregated payment to the one of the providers.

26. The method according to claim 25 further including:
before transferring the EOBs corresponding to the delivered services to the one of the providers, combining the EOBs into a combined BOB, the combined EOB being transferred concurrently with the single aggregated payment.

27. A method comprising:
receiving, at a processor, at least one payment request from at least one payor, the at least one payment request requesting processing of a plurality of payments to be paid by the at least one payor;
determining, via the processor, that the plurality of payments are payable to a service provider for medical services rendered by the service provider;
determining, via the processor, a single payment, the single payment aggregating funds of the at least one payor to pay the plurality of payments requested by the at least one payment request; and
providing, via the processor, an instruction to make the single payment to the service provider.

28. The method of claim 27 further comprising storing information related to the single payment on a server accessible via the world wide web, wherein the information further comprises an explanation of benefits for each of the plurality of payments.

29. The method of claim 27 further comprising: storing information sufficient to identify a service provider's merchant account and pushing the single payment into the service provider's merchant account.

30. The method of claim 29 further comprising: transmitting a notification message to the service provider informing the service provider that the single payment has been transferred into the service provider's merchant account.

31. The method of claim 27 further comprising: storing information sufficient to identify a service provider's bank account and transferring the single payment to the service provider's bank account.

32. The method of claim 31 further comprising: transmitting a notification message to the service provider informing the service provider that the single payment has been transferred into the service provider's bank account.

33. The method of claim 32 wherein the step of transferring the single payment to the service provider's bank account comprising using the Automated Clearing House payment rails.

34. The method of claim 27 further comprising: storing information related to the single payment on a server accessible via the world wide web, wherein the step of storing the information includes storing information related to the at least one payment file and the at least one payor including an explanation of benefits for each at least one payment file.

35. A system comprising:
a processor for executing instructions stored in computer-readable medium on one or more devices to perform operations, the operations comprising:
receiving at least one payment request from at least one payor, the at least one payment request requesting a plurality of payments;
determining that one or more of the plurality of payments are payable to a service provider for medical services rendered by the service provider;
determining a single payment, the single payment aggregating funds to pay the plurality of payments requested by the at least one payment request; and
providing an instruction to make the single payment to the service provider.

36. The system of claim 35 wherein the operations further comprises storing information related to the single payment on a server accessible via the world wide web, wherein the information further comprises an explanation of benefits for each of the plurality of payments.

37. The system of claim 35 wherein the operations further comprises transmitting a notification message to the service provider informing the service provider that the single payment has been transferred into the service provider's merchant account.

38. A computer program product comprising a computer-readable medium embodying program code, the program code comprising:
code for receiving at least one payment request from at least one payor, the at least one payment request requesting a plurality of payments;
code for determining that one or more of the plurality of payments are payable to a service provider for medical services rendered by the service provider;
code for determining a single payment, the single payment aggregating funds to pay the plurality of payments requested by the at least one payment request; and
code for providing an instruction to make the single payment to the service provider.

39. The computer program product of claim 38, the program code further comprising: code for sending a notification to the service provider that the single payment has been made.
